(19) United States
(12) Patent Application Publication
(10) Pub. No.: US 2006/0150141 A1
(43) Pub. Date: Jul. 6, 2006

(54) Method of weaving code fragments between programs using code fragment numbering

(75) Inventors: Seongsoo Hong, Seoul (KR); Jiyong Park, Seoul (KR)

Correspondence Address: GREENBLUM & BERNSTEIN, P.L.C., 1950 ROLAND CLARKE PLACE, RESTON, VA, 20191, US

(73) Assignee: Seoul National University Industry Foundation OF Seoul, Republic of Korea

(21) Appl. No.: 11/203,219

(22) Filed: Aug. 15, 2005

(30) Foreign Application Priority Data
Dec. 30, 2004 (KR) 10-2004-116775

(51) Int. Cl. G06F 9/44

(52) U.S. Cl. 717/105

(57) ABSTRACT

The present invention relates to a method of constructing a new program by weaving codes of various programs. The present invention comprises two ideas described below. First, there is provided a method by which one program inserts a new code fragment into the code of the other program or substitutes a new code fragment for an existing code fragment of the other program. Second, there is provided a method capable of ordering the sequence of code fragments which will be inserted and displayed when a plurality of programs are to insert their code fragments into the same location of a program. The present invention has the following advantages. First, in a case where one program is to insert a code fragment into the other program or substitute a code fragment for an existing code fragment in the other program, the location where the code fragment is inserted or substituted can be arbitrarily determined. Second, two programs can be weaved without modifying a source code of a program to be inserted or substituted. Accordingly, the structure and readability of the program can be maintained as they are, and the troubles imposed on programmers due to code modification can also be reduced. Third, the present invention can have a wide application area because it has been implemented without taking a specific programming language into consideration.

### BACKGROUND OF THE INVENTION

1. Field of the Invention

The present invention relates to a method of constructing a new program through weaving the codes of various programs. The present invention includes the following two methods, i.e., a first method of allowing one program to insert a new code fragment into the code of the other program or substitute a new code fragment for an existing code fragment, and a second method capable of ordering the sequence of code fragments which will be inserted and displayed when a plurality of programs are to insert different code fragments in the same location of a program.

2. Description of the Related Art

The present invention is based on the aspect-oriented programming (AOP). The AOP is a new programming methodology introduced in order to make up for conventional programming methodologies such as the object-oriented programming. The AOP provides a method of modularizing a cross-cutting concern, which cannot be modularized using conventional programming languages, into a new unit called aspect. Accordingly, the use of AOP can modularize a program in more detail and more clearly, so that the development and maintenance of a program can be more easily performed.

In order to make the AOP understood, the concept of the cross-cutting concern used in the AOP will be explained taking a fund transfer program as an example. A fund transfer program is composed of codes that execute SQL statements to transfer a remittance amount from a remittance account to a receiving account, when the remittance account, the receiving account and the remittance amount are entered. For the fund transfer, a user's computer must be checked if an anti-hacking program is loaded, and the user must be authenticated as a valid user. Further, it must be checked that the counterpart bank has properly processed the fund transfer, and the details of the fund transfer must be logged on the system. That is, in order to process a fund transfer, not only the fund transfer function but also the additional functions such as security, authentication and log functions must be implemented at the same time. The codes for the additional functions are coded in a variety of programs, which are scattered over the system, other than the fund transfer programs. Here, the implementing functions (i.e., fund transfer) are referred to as primary concerns, while the additional functions (i.e., security/authentication/log) are referred to as cross-cutting concerns.

Generally, in the object-oriented programming methodology where the AOP is not applied, the program codes with the cross-cutting concerns implemented therein are included in the source codes of the programs with the primary concerns implemented therein. In this methodology, in order to insert/modify/replace/delete a portion of codes with primary or cross-cutting concerns implemented therein, a programmer must find out and modify all the codes of the programs scattered over the system by hand, one by one. That is, since both the primary and cross-cutting concerns are implemented in one program in this method, the readability of the program is decreased and the modification of the code is not easy. Accordingly, there is a problem in that the development/maintenance of a program cannot be easily made.

The AOP has been proposed in order to overcome the above problem, and the AOP defines a programming methodology that deals with cross-cutting concerns. In the AOP, a program is developed using the codes that implement cross-cutting concerns (an advice or a code fragment, referred hereinafter to as a code fragment), and another program is developed using the codes that implement primary concerns. The AOP describes the specifications for weaving the two programs using pointcut information. Hereinafter, a program using the AOP methodology is referred to as an aspect program, while a program using a conventional programming methodology is referred to as a base program. Here, the pointcut is the information on the location of a base program where a specific code fragment of an aspect program is inserted.

FIGS. 1a and 1b illustrate an example of the relations between a base program and an aspect program according to the conventional methodology.

As shown in FIGS. 1a and 1b, various code fragments and the pointcut information on the respective code fragments are described in an aspect program, and it is understood that the development/maintenance of a program becomes easier according to how the pointcut information is described.

In a conventional methodology, i.e. in the previously developed AOP, the locations of a base program where code fragments can be inserted are limited. A pointcut represents a location of insertion, which is described as a subset of predefined types of locations of a base program. The predefined types of locations are, for example, the inside of a specific class, the start and end portions of a function, a portion that calls a specific function, and a portion that reads or writes a specific variable. Assume that there are three functions named a, b and c, and three variables named i, j and k in a base program. At this point, the pointcut is described as “a portion reading a variable j in a function a” or “a portion of a function a or b calling a function c”. More specifically, the types of locations where code fragments can be inserted vary slightly according to AOP languages. However, all are the same in that the location where a code fragment can be inserted is limited.

In this way, a conventional technology has a problem in that a code fragment cannot be inserted in an arbitrary location of a base program. For example, the locations such as “a location performing an iterative statement inside a function” and “a location just prior to performing a branch statement inside a function” cannot be described by a pointcut, and thus, an aspect program cannot insert a code fragment into such locations. Due to such limitations, cross-cutting concerns that can be modularized in aspects are restrictive in the conventional technologies.

On the other hand, in order to insert a code fragment of an aspect program into any location of a base program in a conventional program described above, the following makeshift methods may be used. A code calling a dummy function is added at the insertion location of a base program, or an existing function is divided into two functions at the insertion location and code fragments are then inserted into the start or end portion of the new functions. However, these methods have the problems in that programming efficiency is reduced since the base program should be modified and that readability of the programs is decreased since the structure of the base program is disordered. That is, even in these methods, a programmer must find out and modify the code manually one by one, in the same manner as the conventional object-oriented programming methodology.

### SUMMARY OF THE INVENTION

The present invention is conceived to solve the aforementioned problems in the prior art. An object of the present invention is, first, to provide a method by which one program inserts a new code fragment into the code of the other program or substitutes a new code fragment for an existing code fragment, and, second, to provide a method capable of ordering the sequence of code fragments which will be inserted and displayed when a plurality of programs are to insert different code fragments in the same location of a program.

### BRIEF DESCRIPTION OF THE DRAWINGS

The above and other objects, features and advantages of the present invention will become apparent from the following description of a preferred embodiment given in conjunction with the accompanying drawings, in which:

FIGS. 1a and 1b illustrate an example of the relations between different programs according to a conventional methodology;

FIGS. 2a and 2b illustrate the relations between programs according to an embodiment of the present invention;

FIGS. 3a to 3c illustrate a process of inserting a code fragment or substituting an existing code according to an embodiment of the present invention; and

FIGS. 4a to 4c illustrate an order and substitution relation of a plurality of code fragments to be inserted into the same location according to an embodiment of the present invention.

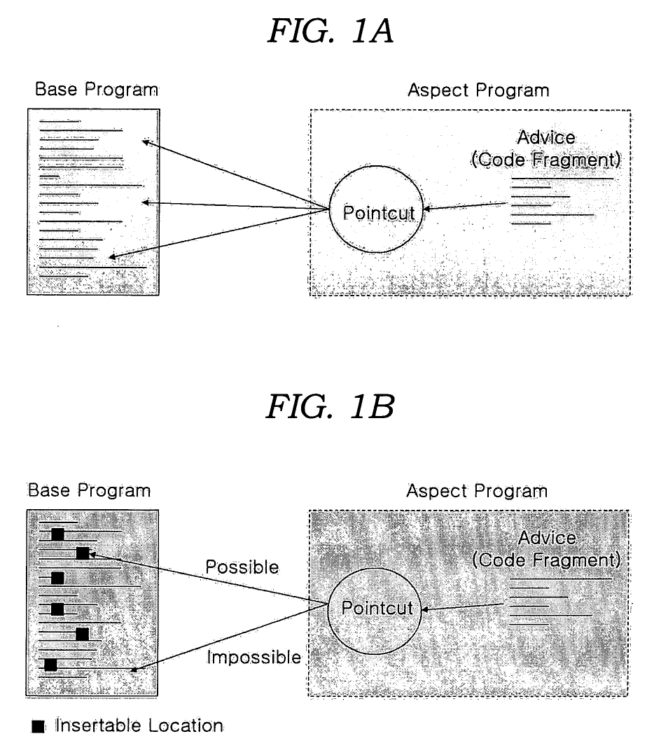

### DETAILED DESCRIPTION OF THE INVENTION

Hereinafter, a preferred embodiment of the invention will be described in detail with reference to the accompanying drawings. In this description, details on well-known functions or constitutions relevant to the present invention will be omitted if they would make the gist of the invention unnecessarily obscure. The terms used in the description are defined considering the functions of the present invention and may vary depending on the intention or usual practice of a user or administrator. Therefore, the definitions should be made based on the entire contents of the description.

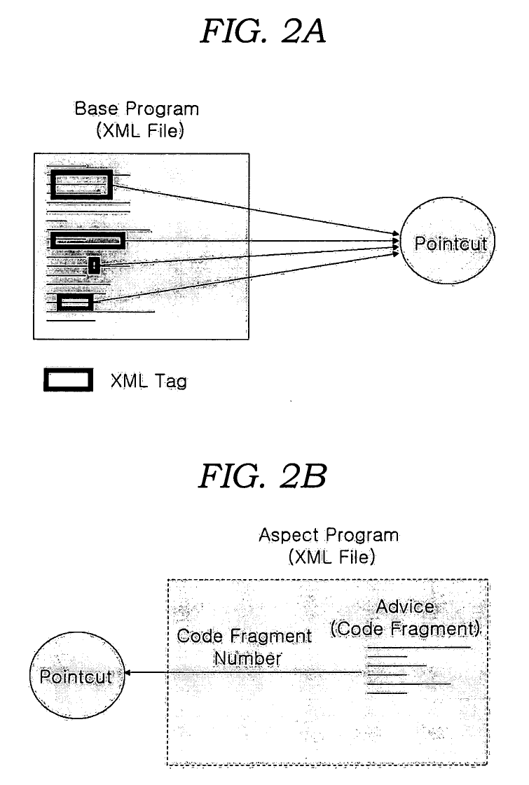

FIGS. 2a and 2b illustrate code fragment numbers according to an embodiment of the present invention. In FIG. 2a, the locations in a base program where aspect programs can insert code fragments are written in XML tags. In FIG. 2b, the locations belonging to a pointcut where an aspect program inserts its own code fragment are also written in XML tags.

As shown in FIG. 2a, the present invention employs XML tags to write the locations in a base program where aspect programs insert code fragments. Thus, base programs are written in the forms of XML documents in which the source codes of an existing program are decorated with XML tags. Additional XML tags are written at each location where a code fragment can be inserted, and each tag has the name of a pointcut, to which the tag itself belongs, as an attribute. In this way, since XML tags can be written at any locations in a source code, the limitation of inserting a code fragment in only the restricted locations is removed. Furthermore, since grammar information (a function name, etc.) of a source code needs not be analyzed in order to write the locations where the codes are inserted, there is an advantage in that the scheme of the present invention can be applied regardless of the types of the programming languages used to write the source code.

As shown in FIG. 2b, an aspect program is also a kind of program. In the present invention, a code fragment is wrapped with XML tags so that the code fragment of an aspect program can be inserted at a specific location of a base program. The name of the pointcut where the code fragment wrapped with the XML tags is inserted is written, as an attribute, in the XML tags. In addition, the XML tag has a code fragment number as an attribute, and thus, an insertion sequence or substitution relation between the different code fragments to be inserted into a specific pointcut is determined. The detailed usage of the code fragment number will be explained later.

It has been explained above that the XML tags of a base program belong to the same pointcut and one code fragment is written in an aspect program, which are simplified for the convenience of explanation. In practice, the XML tags in the base program may belong to different pointcuts, respectively. Further, an aspect program may have a plurality of code fragments, which in turn may be written to be inserted into different pointcuts, respectively.

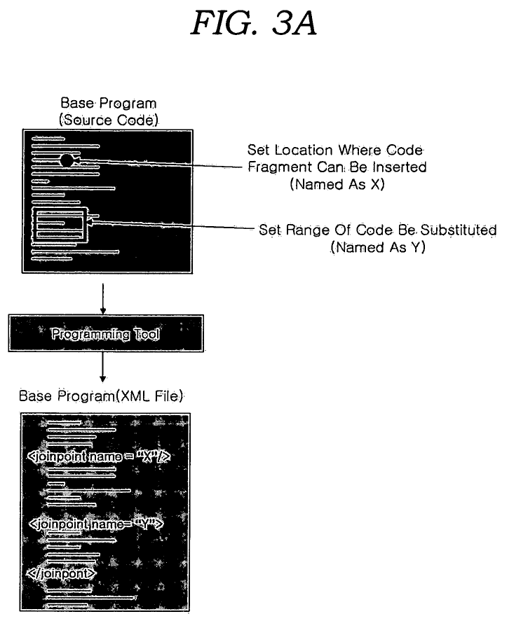

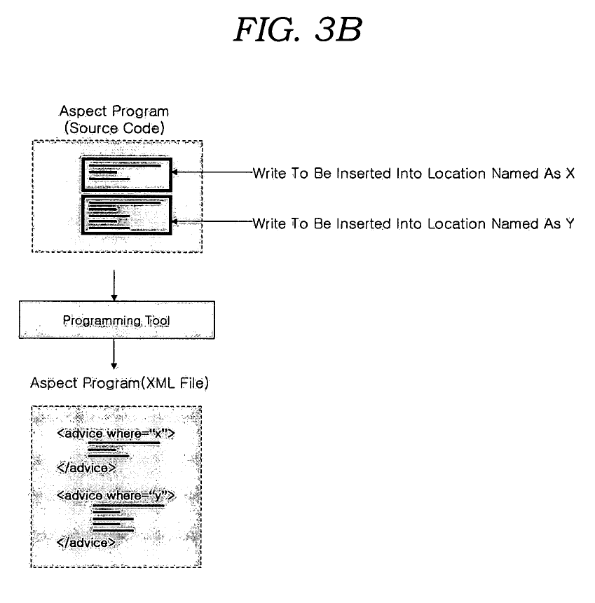

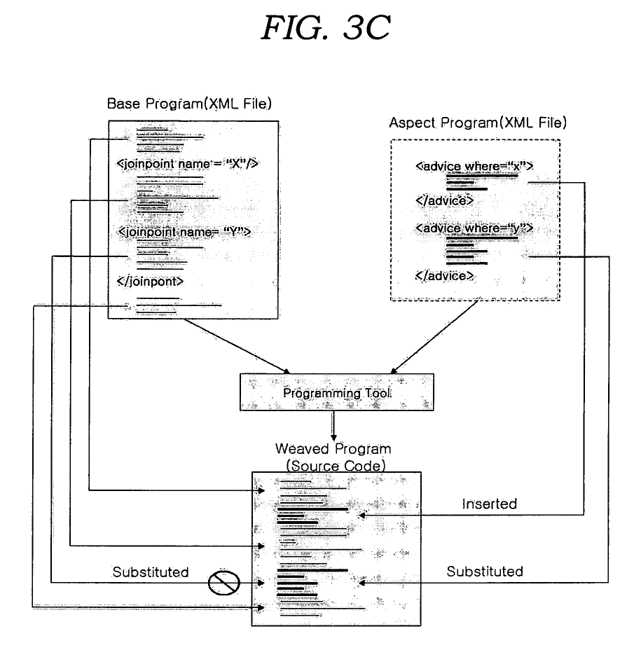

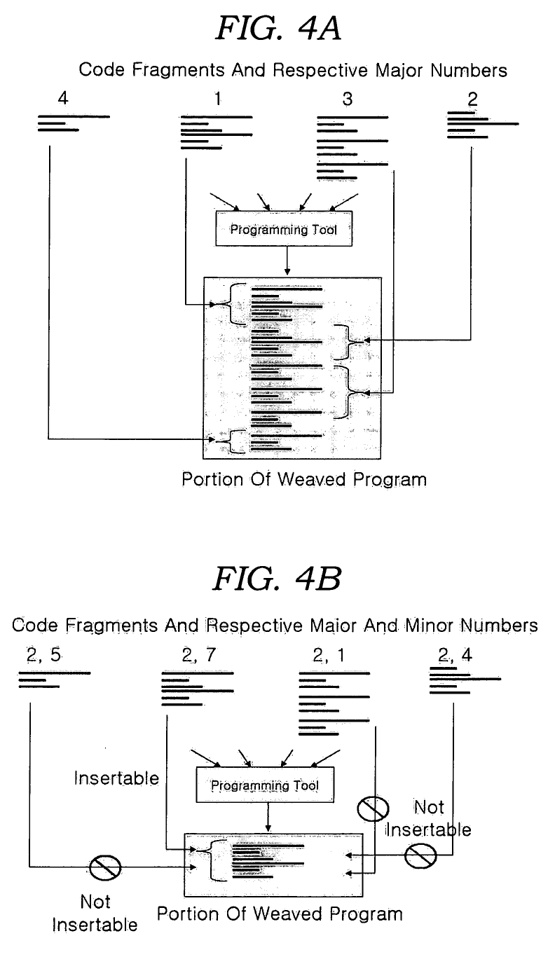

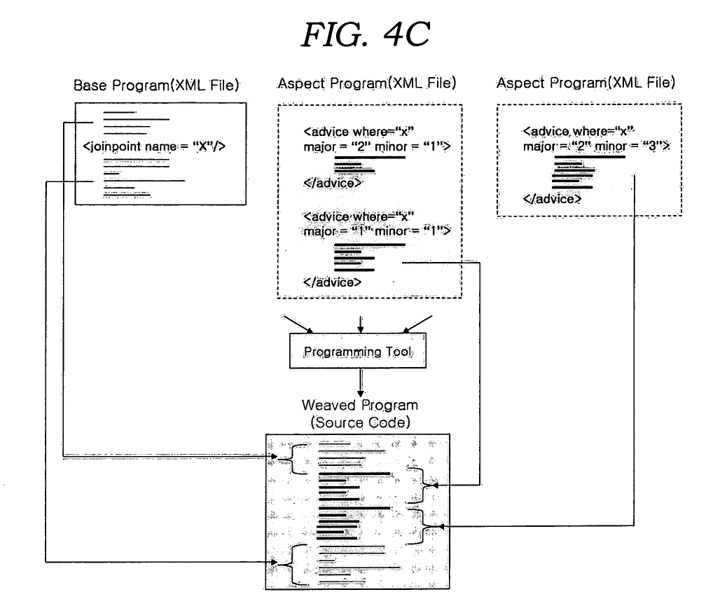

Hereafter, for a better understanding of the present invention, a process of inserting a code fragment of one aspect program into a source code of a base program will be explained with reference to FIGS. 3a to 3c, and a process of determining an order or substitution relation of the code fragments according to the code fragment numbering method when two aspect programs A and B are to insert code fragments into the same location will be explained with reference to FIGS. 4a to 4c.

FIGS. 3a to 3c illustrate the process of inserting a code fragment of an aspect program into a base program according to an embodiment of the present invention, and FIGS. 4a to 4c illustrate the process of determining the order or substitution relation of the code fragments when a plurality of aspect programs is to insert code fragments into the same location according to the present invention.

As described above, in the present invention, a code fragment of an aspect program can be inserted into a source code of a base program and substitute for an existing code fragment of a base program. To this end, code fragment numbers are divided into and defined as major numbers and minor numbers in the present invention. The major number is used for inserting a code fragment of a feature program B between code fragments of a feature program A, while the minor number is used for substituting a code fragment of a feature program B for a code fragment of a feature program A. If a code fragment number “3.4” is taken as an example, the integer portion “3” of the number is named as a major number, while the decimal fraction “4” is name as a minor number.

As shown in FIG. 3a, if a user determines the location where a code fragment is inserted or a range of a code to be substituted with a code fragment in the source code of a base program by using a programming tool of the invention (hereinafter, referred to as a programming tool), the programming tool inserts XML tags at the corresponding locations of the source code. XML tags having no sub-content are inserted at the location where the code fragment is inserted (indicated as a solid circle in FIG. 3a), and XML tags having a code to be substituted as a sub-content are inserted in the range of the code to be substituted by a code fragment (indicated as a rectangle in FIG. 3a). The name of an XML tag (named as ‘jointpoint’ in FIG. 3a) is a portion that can be changed according to specific implementation of the present invention. The respective XML tags have their own name attributes, and thus, can be differentiated from one another. In addition, the XML tags each having the same name can be treated as a single group. Based on the base program created in this manner, a user can write aspect programs and insert new code fragments at the locations where the XML tags are written by using the programming tool.

As shown in FIG. 3b, a user can insert a code fragment of an aspect program into a predetermined location in a base program and substitute a code fragment of an aspect program for an existing code in a base program by using the programming tool. If it is set in such a manner that a specific code fragment of an aspect program can be inserted into the location having a specific name in a base program or substituted for a code existing at the specific location in the base program, the programming tool wraps the code fragment with XML tags. The name of an XML tag (named as ‘advice’ in FIG. 3b) is a portion that can be changed according to specific implementation of the invention. The tag has the name of the location where the code fragment wrapped with the tags is inserted, as an attribute.

As shown in FIG. 3c, if a user weaves a base program written in an XML file and an aspect program written in XML file by using the programming tool, then the programming tool creates a weaved program. The source code of the program created in this way has such a structure that the code fragment of the aspect program is inserted into the location where XML tags are written in a base program, or substituted for the code wrapped with XML tags in a base program. Here, if the location where a certain code fragment of an aspect program is inserted is written as X, the code fragment is inserted into all the locations of the XML tags named as X or substituted for the code wrapped with the XML tags. That is, in FIG. 3c, since the first code fragment of the aspect program has been written to be inserted into the location X, it is inserted in the location of the first tag having the name X in the base program. To the contrary, in FIG. 3c, since the second code fragment of the aspect program has been written to be inserted into the location Y it is substituted for the code at the location of the second tag having the name Y in the base program.

Although the process of weaving one base program and one aspect program has been described in FIG. 3c, it is obvious that the process can be expanded to weave one base program and a plurality of aspect programs altogether. In such a case, one aspect program undoubtedly can also insert a code into a specific location or substitute the code for an existing code of the other aspect program.

In the meantime, a process of determining the sequence and substitution relations of the code fragments when a plurality of aspect programs are to insert or substitute their respective code fragments at predetermined locations are explained below. For this purpose, code fragment numbers are written into XML tags that represent the respective code fragments of an aspect program. Each of the code fragment numbers is divided into a major number and a minor number, each of which can have a numeric value. The major number is used for representing the relative sequence between the code fragments, while the minor number is used for representing the substitution relations between the code fragments.

FIG. 4a shows the usage of a major number. There are four code fragments which have been described as being inserted into the same location of the base program. The order in which the code fragments are inserted and displayed is an ascending order of the major numbers of the respective code fragments. That is, the programming tool inserts the second code fragment having the smallest major number ‘1’ in the first place, inserts the fourth code fragment having the next smallest major number ‘2’ in the next place, and then sequentially inserts the third and the first code fragments having the major number ‘3’ and ‘4’, respectively.

FIG. 4b shows the usage of a minor number. There are four code fragments which have been described as being inserted into the same location of the base program. Each of the code fragments has both a major number and a minor number, which are illustrated in the forms of (major number, minor number) in FIG. 4b. The minor number is used for representing the substitution relations between the code fragments. A code fragment having the biggest minor number among the code fragments having the same major number is substituted for the other code fragments. In FIG. 4b, the respective code fragments have the same major number ‘2’ and have minor numbers ‘5’, ‘7’, ‘1’ and ‘4’, respectively. Accordingly, the second code fragment having the biggest minor number can be substituted for the others code fragments and inserted into the base program. The other code fragments cannot be inserted into the base program.

As shown in FIG. 4c, if a user weaves a base program and an aspect program by using the programming tool, then the programming tool refers to the information written in XML tags and substitutes a code fragment having a smaller minor number with a code fragment having a bigger minor number, among the code fragments having the same major number. Finally, the programming tool creates a program structured in order of the major number. Here, in the source code of the newly created program, only the code fragment having the biggest minor number among the code fragments having the same major number in the aspect program is left, and the code fragments are sorted in order of the major number, i.e., in order from the code fragment corresponding to the code fragment number having the smallest major number to the code fragment corresponding to the code fragment number having the biggest major number.

Although it has been described as an example in the present invention that one code fragment of an aspect program is inserted into one location of a base program or substituted for one code fragment of a base program, it will be readily understood by those skilled in the art that a plurality of code fragments of an aspect program can be inserted into a plurality of locations in a base program or substituted for a plurality of code fragments in a base program. Further, although it has been described as an example that two programs including a base program and an aspect program are weaved, it will also be readily understood by those skilled in the art that a plurality of aspect programs can be selectively combined and weaved.

The present invention has the following advantages. First, in a case where one program is to insert a code fragment into the other program or substitute a code fragment for an existing code fragment in the other program, the location where the code fragment is inserted or substituted can be arbitrarily determined. Second, two programs can be weaved without modifying a source code of a program to be inserted or substituted. Accordingly, the structure and readability of the program can be maintained as they are, and the troubles imposed on programmers due to code modification can also be reduced. Third, the present invention can have a wide application area because it has been implemented without taking a specific programming language into consideration.

Although the present invention have been illustrated and described in connection with the preferred embodiment, the embodiment is given only for merely illustrating the present invention and should not be construed as limiting the scope of the present invention. It will be readily understood by those skilled in the art that various modifications and changes can be made thereto without departing from the spirit and scope of the present invention defined by the appended claims.

1. A method of creating a new program, comprising the steps of:
creating a second program, if it is expressed that another code fragment can be inserted into a specific location of a source code of a first program, the second program being recorded with such information that the another code fragment can be inserted into the specific location of the source code; and
creating a fourth program, if a code fragment existing in a source code of a third program is associated with the specific insertion location of the code fragment of the first program, the fourth program being recorded with such information that the code fragment is scheduled to be inserted into the insertion location,
wherein the created second and fourth programs are analyzed to thereby allow the scheduled code fragment to be actually inserted into every location of the second program where the code fragment can be inserted.

2. A method of creating a new program, comprising the steps of:
creating a second program, if it is expressed that another code fragment can be substituted for a specific code fragment of a source code of a first program, the second program being recorded with such information that the another code fragment can be substituted for the specific code fragment; and
creating a fourth program, if a code fragment existing in a source code of a third program is associated with the specific substitution location of the code fragment of the first program, the fourth program being recorded with such information that the code fragment is scheduled to be substituted for the code fragment at the substitution location,
wherein the created second and fourth programs are analyzed to thereby allow the scheduled code fragment to be actually substituted for every code fragment of the second program to be substituted.

3. The method of weaving code fragments between programs using code fragment numbering as claimed in claim 1, wherein when there are two or more code fragments scheduled to be inserted or substituted at the same location of the second program, major and minor numbers are defined for each code fragment such that the code fragments are arranged in order of the major number from the code fragment having the smallest major number to the code fragment having the biggest major number, and when there are code fragments having the same major number, only the code fragment having the biggest minor number is arranged.

4. The method as claimed in claim 1, wherein the code fragment insertion or substitution location of the second program is written in a text markup language capable of expressing additional information at the corresponding locations of the source code, and the code fragment insertion or substitution location of the fourth program as well as the major and minor numbers of each code fragment are also written in a text markup language.

5. A computer-readable recording medium into which a program for executing the method of weaving code fragments between programs using code fragment numbering according to claim 1, is recorded.

6. The method of weaving code fragments between programs using code fragment numbering as claimed in claim 2, wherein when there are two or more code fragments scheduled to be inserted or substituted at the same location of the second program, major and minor numbers are defined for each code fragment such that the code fragments are arranged in order of the major number from the code fragment having the smallest major number to the code fragment having the biggest major number, and when there are code fragments having the same major number, only the code fragment having the biggest minor number is arranged.

7. The method as claimed in claim 2, wherein the code fragment insertion or substitution location of the second program is written in a text markup language capable of expressing additional information at the corresponding locations of the source code, and the code fragment insertion or substitution location of the fourth program as well as the major and minor numbers of each code fragment are also written in a text markup language.

8. The method as claimed in claim 3, wherein the code fragment insertion or substitution location of the second program is written in a text markup language capable of expressing additional information at the corresponding locations of the source code, and the code fragment insertion or substitution location of the fourth program as well as the major and minor numbers of each code fragment are also written in a text markup language.

9. The method as claimed in claim 6, wherein the code fragment insertion or substitution location of the second program is written in a text markup language capable of expressing additional information at the corresponding locations of the source code, and the code fragment insertion or substitution location of the fourth program as well as the major and minor numbers of each code fragment are also written in a text markup language.

10. A computer-readable recording medium into which a program for executing the method of weaving code fragments between programs using code fragment numbering according to claim 2 is recorded.

11. A computer-readable recording medium into which a program for executing the method of weaving code fragments between programs using code fragment numbering according to claim 3 is recorded.

12. A computer-readable recording medium into which a program for executing the method of weaving code fragments between programs using code fragment numbering according to claim 4 is recorded.

13. A computer-readable recording medium into which a program for executing the method of weaving code fragments between programs using code fragment numbering according to claim 6 is recorded.

14. A computer-readable recording medium into which a program for executing the method of weaving code fragments between programs using code fragment numbering according to claim 7 is recorded.

15. A computer-readable recording medium into which a program for executing the method of weaving code fragments between programs using code fragment numbering according to claim 8 is recorded.

16. A computer-readable recording medium into which a program for executing the method of weaving code fragments between programs using code fragment numbering according to claim 9 is recorded.
